(19) United States
(12) Patent Application Publication
(10) Pub. No.: US 2013/0022282 A1
(43) Pub. Date: Jan. 24, 2013

(54) METHODS FOR CLUSTERING COLLECTIONS OF GEO-TAGGED PHOTOGRAPHS

(71) Applicant: Matthew COOPER, San Francisco, CA (US)

(72) Inventor: Matthew COOPER, San Francisco, CA (US)

(73) Assignee: FUJI XEROX CO., LTD., Tokyo (JP)

(21) Appl. No.: 13/186,365

(22) Filed: Jul. 19, 2011

(51) Int. Cl. G06K 9/62

(52) U.S. Cl. 382/225

(57) ABSTRACT

Systems and methods for clustering photos that include both time stamps and location coordinates. A two step method that first detects boundaries using time and location information independently to form a set of candidate boundaries is implemented. Such boundaries partition the set of time-ordered photos into clusters. A subset of the candidate boundaries is selected by an efficient dynamic programming procedure to optimize a cost function. Several cost functions are used to design clusterings that are coherent in space, time, or both. One set of cost functions minimizes inter-photo distances directly. A second set maximizes an information measure to select clusterings for consistency in both time and space.

### BACKGROUND OF THE INVENTION

As digital photography continues its explosive growth, personal photo collections require more advanced management tools. The increasing availability of geographic information recorded at the time of photo capture represents an opportunity to enhance existing tools. Both digital cameras and more commonly smart phones record latitude and longitude coordinates of photos. Location information can both improve existing time-based organization and provide an alternative framework for organization and retrieval.

Some methods in the art utilize a dynamic programming (DP) approach to temporal photo clustering. This framework enables integrating potential cluster boundaries detected using either time or location information independently. The method chooses boundaries that partition the time-ordered photos into clusters to optimize a cost.

Such methods may also combine temporal and spatial information for photo clustering in a sequence of steps. Initially, time alone is used for a threshold based over-segmentation of the photos. Recorded locations are independently hierarchically grouped into clusters where the number of clusters is automatically determined. In a third pass, temporal-based segments that belong to the same location cluster are merged. This final event segmentation is used for additional processing, such as deriving names for the location clusters, or naming events based on time and location.

Extensions of such methods were designed to support browsing for small displays. Such methods employ a mixture modeling framework with model complexity measures for estimating the number of clusters. For example, there is work on augmenting the hierarchies with more computationally simple techniques for coarse clustering using the Kullback-Leibler (KL) divergence. End to end methods where the first pass performs clustering using mixtures learned jointly on the time and location data are also possible. A variational approach is used to address model order. This is not as analytically daunting as it might appear due to the assumption of Gaussian distributions and the low dimensional (three) feature space. In a second pass, clusters are grouped using KL measures and the mixture parameters.

Hierarchical image annotation using event clustering is also used for some systems. Data may include geotags, and event clustering is done by mean shift clustering. Their method took multiple passes through the photos first processing time and then location.

Some methods also use normalized mutual information (NMI) for event-based analysis across media types and users. Their task is analogous to the event detection and tracking task (TDT) evaluated at TREC. Given a number of heterogeneous information streams, the goal is to identify events and then group documents according to event. For this, the event ground truth was established by events entered at upcoming.org and the data streams included multiple users' geo-tagged photos from Flickr. The preliminary results, based on ensemble clustering, indicated that tags and location are constructive cues, and their combination provided further gains. Their approach relied on supervised training and classification to threshold NMI measures for clustering.

However, improvements can be made over the present art, particularly for event-based clustering.

### SUMMARY OF THE INVENTION

Various embodiments of the inventive methodology are directed to methods and systems that substantially obviate one or more of the above and other problems associated with conventional techniques related to managing digital photographs.

In accordance with one aspect of the present invention, there is provided a computer-implemented method which may involve identifying a plurality of boundaries for grouping a plurality of files based on a first set of one or more attributes to form a plurality of first groups; identifying a plurality of boundaries for grouping the plurality of files based on a second set of one or more attributes to form a plurality of second groups; obtaining a set of clusters R from a union of the first groups and the second groups; and determining a set of clusters S from set of clusters R such a normalized mutual information value (NMI) between R and S is maximized. Dynamic programming may be utilized to determine the set of clusters S.

Additional aspects of the present invention include a non-transitory computer readable medium executing instructions for a process. The process may involve identifying a plurality of boundaries for grouping a plurality of files based on a first set of one or more attributes to form a plurality of first groups; identifying a plurality of boundaries for grouping the plurality of files based on a second set of one or more attributes to form a plurality of second groups; obtaining a set of clusters R from a union of the first groups and the second groups; and determining a set of clusters S from set of clusters R such a normalized mutual information value (NMI) between R and S is maximized. Dynamic programming may be utilized to determine the set of clusters S.

Additional aspects of the present invention include a system, which may involve a boundary unit identifying a plurality of boundaries for grouping a plurality of files based on a first set of one or more attributes attribute to form a plurality of first groups and identifying a plurality of boundaries for grouping the plurality of files based on a second set of one or more attributes to form a plurality of second groups; and a cluster determination unit utilizing a processor to obtain a set of clusters R from a union of the first groups and the second groups; and determine a set of clusters S from set of clusters R such a normalized mutual information value (NMI) between R and S is maximized. Dynamic programming may be utilized to determine the set of clusters S.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify embodiments of the present invention and, together with the description, serve to explain and illustrate principles of the inventive technique. Specifically:

FIG. 1 illustrates an exemplary flowchart according to embodiments of the invention.

FIG. 2 illustrates another exemplary flowchart according to embodiments of the invention.

FIG. 3 illustrates an exemplary functional diagram according to embodiments of the invention.

FIG. 4 illustrates an embodiment of a computer platform upon which the inventive system may be implemented.

### DETAILED DESCRIPTION OF THE INVENTION

Embodiments of the invention exploit location information to enhance event-based photo clustering. This can be done by, for example, sorting the photos in time order and grouping photos into clusters with temporal and spatial coherence. Further embodiments of the invention employ methods that combine similarity-based event boundary detection and dynamic programming for boundary selection. We also present a variation that uses information measures to cluster photos.

Event based clustering can be improved by ensemble clustering in which a final (photo) clustering must be determined from a set of available clusterings. For example, a confidence score can be used to rank temporal clusterings performed at different scales. Embodiments of the present invention further extend this approach to spatial clustering as a baseline for comparison in our experiments. Dynamic Programming (DP) is then used to directly optimize a related score.

Mutual information provides a measure of the consistency of two clusterings. Assume that a valid clustering assigns each photo to exactly one cluster, and that the union of the clusters is the original set of N photos. Consider two clusterings S={s₁, , s_{A}} and R={r₁, . . . , r_{B}}. The mutual information between R and S is:

$$I ( R ; S ) = {\sum }_{r ∈ R , s ∈ S} P ( r , s ) log ( \frac{P ( r , s )}{P ( r ) P ( s )} ) \\ where P ( r ) = \frac{\vert r \vert}{N} and P ( r , s ) = \frac{\vert r ⋂ s \vert}{N} \qquad ( 1 )$$

Direct application of mutual information favors over-segmentation. To counter this, normalized forms may be utilized.

To cluster photos by location, embodiments of the invention adapt the time-based boundary detection by using an appropriate spatial distance measure. Embodiments of the invention then extend the concept of dynamic programming (DP) clustering by two methods. One method used is directed to the combinations of bounds detected by using temporal and spatial information as input to the DP procedure. Another method used incorporates location information using new cost functions that combine temporal and spatial information. These methods are non-parametric and utilize DP to directly optimize cluster fitness measures.

Embodiments of the invention use the normalized mutual information (NMI):

$$NMI ( R ; S ) = \frac{I ( R ; S )}{\sqrt{H ( R ) H ( S )}} \qquad ( 2 )$$

where H(R)=−ΣᵣP(r)log(P(r)) is the entropy of the clustering R.

Dynamic Programming is used to construct a clustering that maximizes the NMI averaged over all available clusterings.

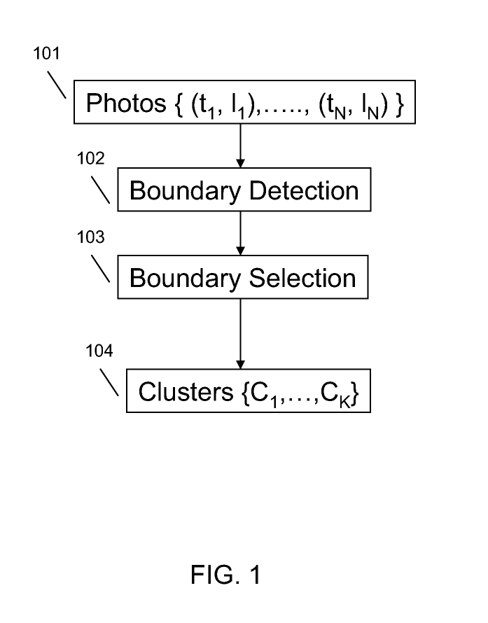

FIG. 1 illustrates an exemplary flowchart for a method according to embodiments of the invention. There are two basic steps: boundary detection 102 and boundary selection 103. The ith photo has an associated time and location (ti, li) 101 and is assigned to a single cluster Ck 104. Different configurations of the system are produced by combining various possible choices for the boundary detection and selection steps.

For example, the boundary detection 102 can be based on similarity based detection according to temporal or spatial attribute, or both in combination. The boundary detection 102 can also be based on affinity propagation for analyzing for a spatial attribute.

Boundary selection 103 may utilize dynamic programming to select boundaries based on similarity or based on NMI. The similarity or NMI selection can be based on a temporal or spatial attribute, or both in combination.

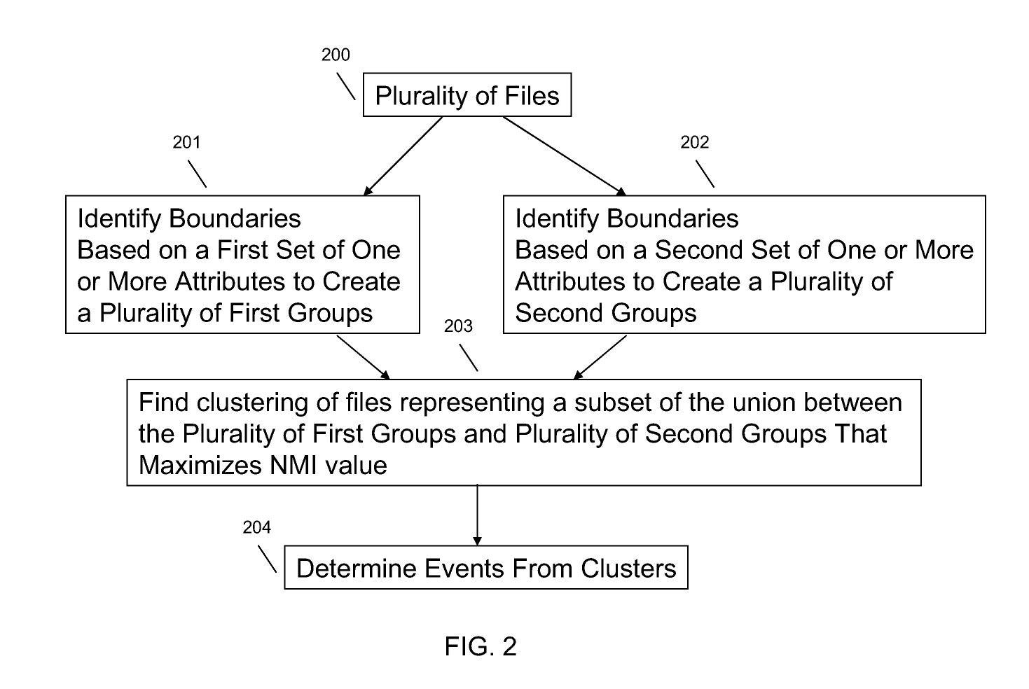

FIG. 2 illustrates an exemplary flowchart according to embodiments of the invention. A plurality of files 200 is analyzed to identify boundaries based on a first set of one or more attributes to create a plurality of first groups 201 and a second set of one or more attributes to create a plurality of second groups 202. As mentioned previously, the attributes can be temporal or spatial attributes, depending on the content of the files. Other attributes are also possible for event or content based ordering, such as color similarity of photos, usage data, audio attributes for audio files, and so forth. From the two attributes, a clustering of files is identified representing a subset of the union between the first groups and the second groups that maximizes the NMI value 203. Depending on the type of ordering, events can then be identified based on the clusters 204.

The first step is to assemble a set of candidate event boundaries that partition the time-ordered photo stream. A subset of the candidates will be selected that define the final clusters. For temporal boundary detection, embodiments of the invention build a hierarchical temporal segmentation using an exponential family of inter-photo similarity measures:

$${s}_{τ} ( i , j ) = exp ( - \frac{\vert {t}_{i} - {t}_{j} \vert}{τ} ) . \qquad ( 3 )$$

τ is varied to produce a set of segmentations. For location based event boundary detection, embodiments of the invention use the approximate distance between photo locations:

$${s}_{σ} ( i , j ) = exp ( - \frac{{d}_{g} ( {l}_{i} , {l}_{j} )}{σ} ) . \qquad ( 4 )$$

where d_{g} is the distance using the appropriate geodesic computed assuming the earth is spherical.

In contrast to time, location is not naturally ordered. Moreover, photographers may revisit locations over time contrary to a normal assumption of disjoint, contiguous clusters. Therefore, for a more natural clustering of locations, embodiments of the invention utilize affinity propagation for boundary detection. This technique does not assume any order in the data, but has the computational disadvantage that it requires a complete pairwise inter-photo distance matrix. The granularity of the clustering is determined by a “preference” parameter which is swept across a broad range to generate a multi-scale set of spatial clusterings.

The purpose of the boundary detection step is to produce the set of candidate boundaries. For the “combined” segmentation, we simply combine the boundaries from the independent spatial and temporal segmentations to form the set of candidates.

Dynamic programming (DP) for boundary selection associates a cost with each potential photo cluster. Embodiments of the invention then determine a final partitioning to optimize the total cost. A DP procedure for grouping an ordered set of objects may be utilized to implement the partitioning. We begin with the set of boundaries detected in the previous step, denoted B. Generally, β=|B|<<N, the number of photos. Define the cost of the cluster between photos at boundary indices bᵢ and bⱼ to be the total pairwise distance between photos within the cluster:

$${C}_{F} ( {b}_{i} , {b}_{j} ) = {\sum }_{m , n = {b}_{i}}^{{b}_{j} - 1} d ( m , n ) . \qquad ( 5 )$$

Consider three distance measures:

$$d ( m , n ) = \{ \begin{matrix}\vert {t}_{m} - {t}_{n} \vert & for temporal selection \\ {d}_{g} ( {l}_{m} , {l}_{n} ) & for spatial selection \\ max ( \vert {t}_{m} - {t}_{n} \vert , {d}_{g} ( {l}_{m} , {l}_{n} ) ) & for combined selection .\end{matrix}$$

The choice of the simple maximum for combined selection penalizes clusters that are not consistent in both time and location. The embodiments of the invention successively build minimum cost partitions with m boundaries based on the minimum cost partition with m−1 boundaries. First, the minimum cost is computed for a two cluster segmentation of the photos indexed 1, . . . , bⱼ:

$${E}_{F} ( j , 2 ) = {min}_{2 \leq i \leq j} {C}_{F} ( 1 , {b}_{i} ) + {C}_{F} ( {b}_{i} , {b}_{j} ) , \\ i \leq j \leq β . \qquad ( 6 )$$

E_{F}(j,m) is the optimal partition of the photos with indices 1, . . . , bⱼ with cardinality m. This procedure is repeated to compute

$${E}_{F} ( j , L ) = {min}_{L \leq i \leq j} {E}_{F} ( i , L - 1 ) + {C}_{F} ( i , j ) , \\ L \leq j \leq β , 3 \leq L \leq β . \qquad ( 7 )$$

The result is a set of minimum cost partitions with cardinality 3, . . . , β. A traceback step identifies the boundaries in each of the optimal partitions. As the number of clusters increases, the total cost of the partition decreases monotonically. Various criteria have been proposed for selecting the optimal number of clusters, K, based on the total partition cost. Utilize a heuristic:

$$\begin{matrix}{K}^{*} = {arg max}_{2 \leq m \leq β - 1} g ( m ) , \\ where & ( 8 ) \\ g ( m ) = \frac{{E}_{F} ( β , m )}{{E}_{F} ( β , m + 1 )} . & ( 9 )\end{matrix}$$

The complexity for computing the costs C_{F} is quadratic in β, the number of detected peaks in the novelty scores providing relative efficiency.

Using Normalized Mutual Information

Embodiments of the invention also use DP to maximize an NMI cost directly. For this, embodiments of the invention convert the set of boundaries detected using either time or location at a specific scale into a corresponding clustering (i.e. we sort the detected boundaries and assign each segment a discrete label). Because boundaries are detected across a range of scales independently for time and space, the result is a set of such clusterings. Denote this set to be [symbol] . The total cost to maximize is the average NMI between any proposed clustering S and each clustering Rε [symbol] .

$$\frac{1}{\vert ℜ \vert} {\sum }_{R ∈ ℜ} NMI ( R ; S ) .$$

The idea is to identify the clustering S that maximizes the average NMI with all clusterings in R, each of which capture structure in the photo collection in either space or time at some specific scale. Define the cost of including a possible cluster in S. First, decompose a single term in the above sum using the definition in (2):

$$\begin{matrix}NMI ( R ; S ) = \frac{1}{\sqrt{H ( S )}} {\sum }_{s ∈ S} P ( s ) \frac{1}{\sqrt{H ( R )}} {\sum }_{r ∈ R} P ( r \vert s ) log ( \frac{P ( r \vert s )}{P ( r )} ) & ( 10 ) \\ = \frac{1}{\sqrt{H ( S )}} {\sum }_{s ∈ S} P ( s ) \frac{1}{\sqrt{H ( R )}} I ( s ; R ) . & ( 11 )\end{matrix}$$

I(s;R) is the rightmost summation of (10). The equations show how a given cluster S contributes to NMI(R; S). Let Sᵢⱼ be the cluster of photos between candidate boundaries bᵢ and bⱼ. Define a cost for maximization by DP as in (5):

$${C}_{NMI} ( {b}_{i} , {b}_{j} ) = \frac{1}{\vert ℜ \vert} {\sum }_{R ∈ ℜ} P ( {s}_{ij} ) \frac{I ( {s}_{ij} ; R )}{\sqrt{H ( R )}} , \\ = \frac{\vert {b}_{j} - {b}_{i} \vert}{\vert ℜ \vert \cdot N} {\sum }_{R ∈ ℜ} \frac{1}{\sqrt{H ( R )}} {\sum }_{r ∈ R} P ( r \vert {s}_{ij} ) log ( \frac{P ( r \vert {s}_{ij} )}{P ( r )} ) . \qquad ( 12 )$$

This cost can be inserted into the procedure described previously in (6) and (7), replacing minimization with maximization. Note that the H(S) term is ignored from (10) in the cost of (13). This is borne largely of analytical convenience, although the result remains a useful measure. There is no simple way to include the entropy of the global clustering S inside this local cost of the cluster Sᵢⱼ. For final clustering selection, this can be corrected. The DP procedure thus maximizes a scaled form of the average NMI:

$${E}_{NMI} ( S ) = \frac{1}{\vert ℜ \vert} {\sum }_{R ∈ ℜ} \frac{I ( R ; S )}{\sqrt{H ( R )}} . \qquad ( 13 )$$

The H(R) terms provide an implicit weighting to each clustering R. Generally, this preferentially weights clusterings with fewer clusters. This is consistent with the intuition that boundaries detected at coarser scales are more important. As before, determining the final clustering requires selecting the final number of clusters, K. This is achieved by first computing and maximizing the average NMI. Then the range of possible values of K, determined by the number of candidate boundaries, 3<=K<=β is considered. For each, a traceback step is performed to select the boundaries that maximize the cost of (13). We denote the corresponding clustering SK, and compute its entropy. The final error resulting from the traceback step is then scaled to determine the average NMI. The final clustering with the number of clusters can then be selected:

$${K}^{*} = {arg max}_{3 \leq K \leq β} ( \frac{1}{\sqrt{H ( {S}_{K} )}} {E}_{NMI} ( {S}_{K} ) ) . \qquad ( 14 )$$

Experimental Results

Four sets of photos (82<N<245) were used, including the photographers' ground truth event clusterings for evaluation. A number of experiments were performed that are summarized here with average performance measures over the four collections. Precision and recall, and their geometric mean, the F1 score are used to assess different versions of embodiments of the invention. Aspects of this test set are challenging. The size of labeled event clusters is as small as two photos, and one data set includes a bus tour with large location changes between photos taken in close temporal proximity.

Similarity Based Clustering

The similarity based methods are based on a conventional framework and provide a baseline against which the DP approaches of the invention are tested. Table 1 shows results for several variations. The fitness score is used to select a single level in the hierarchical tree of segmentations as a final clustering. The best results are produced using temporal boundary detection with a cluster fitness score based on spatial similarity. This demonstrates that location and time provide complementary information for event clustering. The number of clusters columns show the ground truth average (GT) and the detected average (DET) over the four test sets.

TABLE 1
Summary statistics for similarity-based clustering
using the conventional framework.

| Boundary | Fitness | # clusters | | | | |
|---|---|---|---|---|---|---|
| Detection | score | GT | DET | Precision | Recall | F1 score |
| Temporal | temporal | 8.75 | 7.75 | 0.487337662 | 0.415018315 | 0.439393939 |
| Temporal | spatial | 8.75 | 7.5 | 0.519480519 | 0.456684982 | 0.477661228 |
| Temporal | combined | 8.75 | 7.75 | 0.487337662 | 0.415018315 | 0.439393939 |
| Spatial | spatial | 8.75 | 9.25 | 0.386217949 | 0.42014652 | 0.401748252 |
| Spatial | temporal | 8.75 | 9.75 | 0.370833333 | 0.42014652 | 0.393506494 |
| Spatial | combined | 8.75 | 9.25 | 0.386217949 | 0.42014652 | 0.401748252 |

Clustering Via DP—Using Time and Location Directly

Table 2 shows results using DP. To assemble the candidate boundaries, embodiments of the invention apply the similarity-based approach using temporal information, spatial information, or both, as before. For boundary selection, embodiments of the invention consider three inter-photo distances for the cost of (5): temporal, spatial, and combined (maximum). Performance improves on all the baselines by combining the candidate boundaries detected using spatial and temporal information and using DP for selection with either the temporal or combined cost. The DP procedure is able to more effectively combine the location and time information for clustering. Using the spatial cost function with the combined boundary set produces over-segmentation and degrades performance.

TABLE 2
Summary statistics for clustering with DP using time and location
directly in accordance to embodiments of the invention.

| Boundary | | # clusters | | | | |
|---|---|---|---|---|---|---|
| Detection | DP Cost | GT | DET | Precision | Recall | F1 score |
| Temporal | Temporal | 8.75 | 7.75 | 0.558333333 | 0.420970696 | 0.461956522 |
| Temporal | Special | 8.75 | 6.5 | 0.5125 | 0.33489011 | 0.396464646 |
| Temporal | Combined | 8.75 | 7.5 | 0.558333333 | 0.420970696 | 0.461956522 |
| Spatial | Spatial | 8.75 | 9.5 | 0.275 | 0.281868132 | 0.278306878 |
| spatial | temporal | 8.75 | 7.75 | 0.485416667 | 0.365201465 | 0.415084915 |
| spatial | combined | 8.75 | 7.75 | 0.485416667 | 0.365201465 | 0.415084915 |
| combined | temporal | 8.75 | 9 | 0.586309524 | 0.467765568 | 0.516239316 |
| combined | spatial | 8.75 | 10.75 | 0.385267857 | 0.412820513 | 0.393025078 |
| combined | combined | 8.75 | 9 | 0.586309524 | 0.467765568 | 0.516239316 |

Clustering Via DP—Using NMI

Table 3 shows results using DP with the scaled NMI cost of (13). Boundaries are detected as before. The final clustering is selected to maximize the average NMI relative to the set of clusterings R. The boundaries used to generate R are indicated in the column with the heading R. Performance improves on the baselines of Table 1. Not surprisingly, the NMI approach improves as the number of available clusterings in the set R increases. Hence the “combined” rows for the column R that use both multi-scale spatial and temporal clusterings to comprise R show the best performance. Using all detected boundaries as candidates for selection allows the “combined”/“combined” system to perform best, almost as well as the best DP systems in Table 2. Variants are included that use location-based affinity propagation to generate clusterings included in R. The performance of these systems is relatively poor indicating the importance of temporal order for this problem.

TABLE 3
Summary statistics for clustering with DP using NMI
in accordance to embodiments of the invention.

| Boundary | | # clusters | | | | |
|---|---|---|---|---|---|---|
| Detection | [symbol] | GT | DET | Precision | Recall | F1 score |
| temporal | temporal | 8.75 | 6.25 | 0.529761905 | 0.418223443 | 0.441399287 |
| temporal | special | 8.75 | 5.25 | 0.604166667 | 0.354120879 | 0.444856459 |
| temporal | combined | 8.75 | 6.5 | 0.571428571 | 0.456684982 | 0.494327894 |
| temporal | AP | 8.75 | 6.75 | .0563095238 | 0.415018315 | 0.46038961 |
| temporal | temporal + AP | 8.75 | 7 | 0.44047619 | 0.98992674 | 0.407575758 |
| spatial | spatial | 8.75 | 6.25 | 0.469047619 | 0.295970696 | 0.356886535 |
| spatial | temporal | 8.75 | 5.5 | 0.358333333 | 0.263461538 | 0.300106326 |
| spatial | combined | 8.75 | 7 | 0.545833333 | 0.426098901 | 0.477855478 |
| spatial | temporal + AP | 8.75 | 6.25 | 0.4625 | 0.33489011 | 0.372964944 |
| combined | temporal | 8.75 | 6.5 | .0327380952 | 0.335897436 | 0.328030303 |
| combined | spatial | 8.75 | 6.75 | .0464583333 | 0.357509158 | 0.399096225 |
| combined | combined | 8.75 | 8 | 0.577380952 | 0.467765568 | 0.509880952 |
| combined | temporal + AP | 8.75 | 7 | 0.447916667 | 0.390842491 | 0.395187166 |

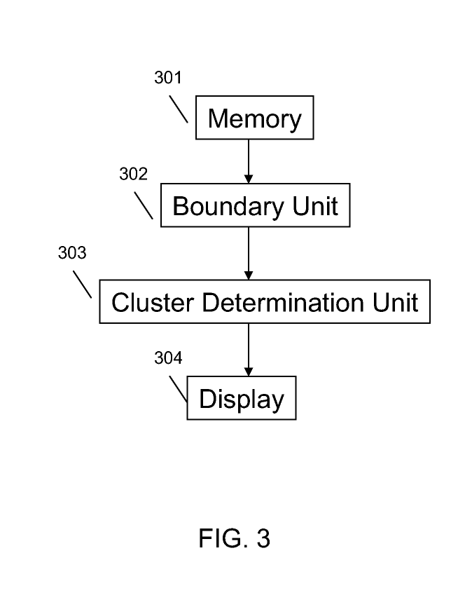

FIG. 3 illustrates an exemplary functional diagram according to embodiments of the invention. Files may be stored in a memory 301 and sent to a boundary unit 302 for boundary detection. Subsequently, a cluster determination unit 303 may be used to determine clusters based on the boundary detection, with the result being displayed on a display 304.

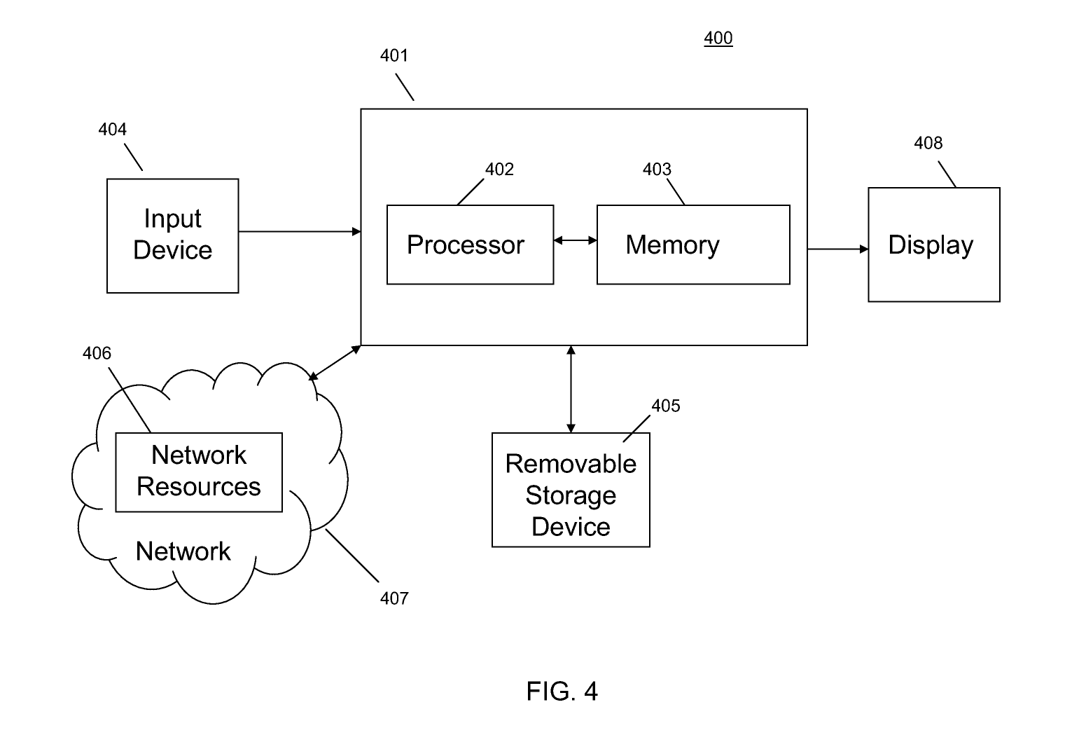

FIG. 4 is a block diagram that illustrates an embodiment of a computer/server system 400 upon which an embodiment of the inventive methodology may be implemented. The system 400 includes a computer/server platform 401 including a processor 402 and memory 403 which operate to execute instructions, as known to one of skill in the art. The term “computer-readable medium” as used herein refers to any medium that participates in providing instructions to processor 402 for execution. Additionally, the computer platform 401 receives input from a plurality of input devices 404, such as a keyboard, mouse, touch device or verbal command. The computer platform 401 may additionally be connected to a removable storage device 405, such as a portable hard drive, optical media (CD or DVD), disk media or any other medium from which a computer can read executable code. The computer platform may further be connected to network resources 406 which connect to the Internet or other components of a local public or private network. The network resources 406 may provide instructions and data to the computer platform from a remote location on a network 407. The connections to the network resources 406 may be via wireless protocols, such as the 802.11 standards, Bluetooth® or cellular protocols, or via physical transmission media, such as cables or fiber optics. The network resources may include storage devices for storing data and executable instructions at a location separate from the computer platform 401. The computer interacts with a display 408 to output data and other information to a user, as well as to request additional instructions and input from the user. The display 408 may therefore further act as an input device 404 for interacting with a user.

Moreover, other implementations of the invention will be apparent to those skilled in the art from consideration of the specification and practice of the invention disclosed herein. Various aspects and/or components of the described embodiments may be used singly or in any combination in the file grouping system. It is intended that the specification and examples be considered as exemplary only, with a true scope and spirit of the invention being indicated by the following claims.

1. A method, comprising:
identifying a plurality of boundaries for grouping a plurality of files based on a first set of one or more attributes to form a plurality of first groups;
identifying a plurality of boundaries for grouping the plurality of files based on a second set of one or more attributes to form a plurality of second groups;
utilizing a processor to obtain a set of clusters R from a union of the first groups and the second groups; and
determining a set of clusters S from the set of clusters R such that a normalized mutual information value (NMI) between R and S is maximized, wherein dynamic programming is utilized to determine the set of clusters S.

2. The method of claim 1, wherein the normalized mutual information score is calculated as:
$$NMI ( R ; S ) = \frac{I ( R ; S )}{\sqrt{H ( R ) H ( S )}} ;$$
$$wherein$$
$$I ( R ; S ) = {\sum }_{r ∈ R , s ∈ S} P ( r , s ) log ( \frac{P ( r , s )}{P ( r ) P ( s )} )$$
$$where$$
$$P ( r ) = \frac{\vert r \vert}{N}$$
$$and$$
$$P ( r , s ) = \frac{\vert r ⋂ s \vert}{N} ;$$
$$wherein$$
$$H ( R ) = - {\sum }_{r} P ( r ) log ( P ( r ) ) ;$$
and
wherein N is a total number of the files.

3. The method of claim 1, wherein one of the first set and the second set is temporal information and wherein one of the first set and the second set is spatial information.

4. The method of claim 3, wherein one of the first set and the second set is color similarity.

5. The method of claim 3, wherein the files are photos.

6. The method of claim 1, further comprising grouping the plurality of files based on events; the grouping based on the set of clusters S.

7. A non-transitory computer readable medium having stored thereon instructions that when executed by a processor perform a process comprising:
identifying a plurality of boundaries for grouping a plurality of files based on a first set of one or more attributes to form a plurality of first groups;
identifying a plurality of boundaries for grouping the plurality of files based on a second set of one or more attributes to form a plurality of second groups;
obtaining a set of clusters R from a union of the first groups and the second groups; and
determining a set of clusters S from set of clusters R such a normalized mutual information value (NMI) between R and S is maximized, wherein dynamic programming is utilized to determine the set of clusters S.

8. The non-transitory computer readable medium of claim 7, wherein the normalized mutual information score is calculated as:
$$NMI ( R ; S ) = \frac{I ( R ; S )}{\sqrt{H ( R ) H ( S )}} ;$$
$$wherein$$
$$I ( R ; S ) = {\sum }_{r ∈ R , s ∈ S} P ( r , s ) log ( \frac{P ( r , s )}{P ( r ) P ( s )} )$$
$$where$$
$$P ( r ) = \frac{\vert r \vert}{N}$$
$$and$$
$$P ( r , s ) = \frac{\vert r ⋂ s \vert}{N} ;$$
$$wherein$$
$$H ( R ) = - {\sum }_{r} P ( r ) log ( P ( r ) ) ;$$
and
wherein N is a total number of the files.

9. The non-transitory computer readable medium of claim 7, wherein one of the first set and the second set is temporal information and wherein one of the first set and the second set is spatial information.

10. The non-transitory computer readable medium of claim 7, wherein one of the first set and the second set is color similarity.

11. The non-transitory computer readable medium of claim 9, wherein the files are photos.

12. The non-transitory computer readable medium of claim 7, further comprising grouping the plurality of files based on events; the grouping based on the set of clusters S.

13. A system, comprising:
a boundary unit identifying a plurality of boundaries for grouping a plurality of files based on a first set of one or more attributes to form a plurality of first groups and identifying a plurality of boundaries for grouping the plurality of files based on a second set of one or more attributes to form a plurality of second groups;
a cluster determination unit utilizing a processor to obtain a set of clusters R from a union of the first groups and the second groups; and determine a set of clusters S from the set of clusters R such that a normalized mutual information value (NMI) between R and S is maximized, wherein dynamic programming is utilized to determine the set of clusters S.

14. The system of claim 13, wherein the cluster determination unit calculates the normalized mutual information value as:
$$NMI ( R ; S ) = \frac{I ( R ; S )}{\sqrt{H ( R ) H ( S )}} ;$$
$$wherein$$
$$I ( R ; S ) = {\sum }_{r ∈ R , s ∈ S} P ( r , s ) log ( \frac{P ( r , s )}{P ( r ) P ( s )} )$$
$$where$$
$$P ( r ) = \frac{\vert r \vert}{N}$$
$$and$$
$$P ( r , s ) = \frac{\vert r ⋂ s \vert}{N} ;$$
$$wherein$$
$$H ( R ) = - {\sum }_{r} P ( r ) log ( P ( r ) ) ;$$
and
wherein N is a total number of the files.

15. The system of claim 13, wherein one of the first set and the second set is temporal information and wherein one of the first set and the second set is spatial information.

16. The system of claim 13, wherein one of the first set and second set is color similarity.

17. The system of claim 15, wherein the files are photos.

18. The system of claim 13, further comprising a grouping unit grouping the plurality of files based on events; the grouping based on the set of clusters S.
